(19) United States
(12) Patent Application Publication
(10) Pub. No.: US 2025/0383499 A1
(43) Pub. Date: Dec. 18, 2025

(54) SEMICONDUCTOR PHOTONIC DEVICE AND METHOD OF MANUFACTURING THE SAME

(71) Applicant: TAIWAN SEMICONDUCTOR MANUFACTURING COMPANY LTD., HSINCHU (TW)

(72) Inventors: SHENG KAI YEH, TAICHUNG CITY (TW); SHIH CHI LIU, HSINCHU (TW); SHU-WEI CHANG, TAIPEI CITY (TW); FENG YUAN, HSINCHU CITY (TW); CHI-YUAN SHIH, HSINCHU (TW); SHIH-FEN HUANG, HSINCHU COUNTY (TW); BEIH-TZUN LIN, HSINCHU CITY (TW)

(21) Appl. No.: 18/741,837

(22) Filed: Jun. 13, 2024

(51) Int. Cl. G02B 6/132; G02B 6/12

(52) U.S. Cl. CPC G02B 6/132; G02B 6/12004; G02B 2006/12102; G02B 2006/12135; G02B 2006/12188

(57) ABSTRACT

A method of manufacturing a semiconductor photonic device includes: providing a first substrate comprising a base layer, an insulator layer overlying the base layer, and a surface layer overlying the insulator layer; forming an optical coupler in the surface layer of the first substrate; forming a temperature control member partially encircling the optical coupler; removing the base layer of the first substrate; and depositing a thermal preservation layer on the insulator layer of the first substrate, wherein the base layer of the first substrate has a first thermal conductivity and the thermal preservation layer has a second thermal conductivity less than the first thermal conductivity.

### BACKGROUND

Modern technological advances, such as big data, cloud computation, cloud storage, and Internet of Things (IoT), have driven exponential growth of various applications in processing and communication of data, e.g., high-performance computers, data centers, and long-haul telecommunications. To address the emerging need for high-speed data transmission, a modern semiconductor structure may include optical elements for providing optical data links to improve the data transmission rate of existing electrical data links.

### BRIEF DESCRIPTION OF THE DRAWINGS

Aspects of the present disclosure are best understood from the following detailed description when read with the accompanying figures. It should be noted that, in accordance with standard practice in the industry, various features are not drawn to scale. In fact, dimensions of the various features may be arbitrarily increased or reduced for clarity of discussion.

FIG. 1 is a schematic top view of a semiconductor photonic device, in accordance with some embodiments of the present disclosure.

FIG. 2 is a schematic cross-sectional view along a line A-A′ of the semiconductor photonic device in FIG. 1.

FIG. 3 is a schematic top view of a semiconductor photonic device, in accordance with some embodiments of the present disclosure.

FIG. 4 is a schematic cross-sectional view along a line B-B′ of the semiconductor photonic device in FIG. 3.

FIG. 5 is a schematic top view of a semiconductor photonic device, in accordance with some embodiments of the present disclosure.

FIG. 6 is a schematic top view of a semiconductor photonic device, in accordance with some embodiments of the present disclosure.

FIG. 7 is a flowchart of a method of manufacturing a semiconductor photonic device, in accordance with some embodiments of the present disclosure.

FIGS. 8A to 8M are cross-sectional views of intermediate stages of the method of manufacturing a semiconductor photonic device, in accordance with some embodiments of the present disclosure.

FIG. 9 is a flowchart of a method of manufacturing a semiconductor photonic device, in accordance with some embodiments of the present disclosure.

FIGS. 10A to 10L are cross-sectional views of intermediate stages of the method of manufacturing a semiconductor photonic device, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for a purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first,” “second” and “third” describe various elements, components, regions, layers and/or sections, but these elements, components, regions, layers and/or sections should not be limited by these terms. These terms may be only used to distinguish one element, component, region, layer or section from another. The terms such as “first,” “second” and “third” when used herein do not imply a sequence, order, or importance unless clearly indicated by the context.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the normal deviation found in the respective testing measurements. Also, as used herein, the terms “substantially,” “approximately” or “about” generally mean within a value or range (e.g., within 10%, 5%, 1%, or 0.5% of a given value or range) that can be contemplated by people having ordinary skill in the art. Alternatively, the terms “substantially,” “approximately” or “about” mean within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “substantially,” “approximately” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

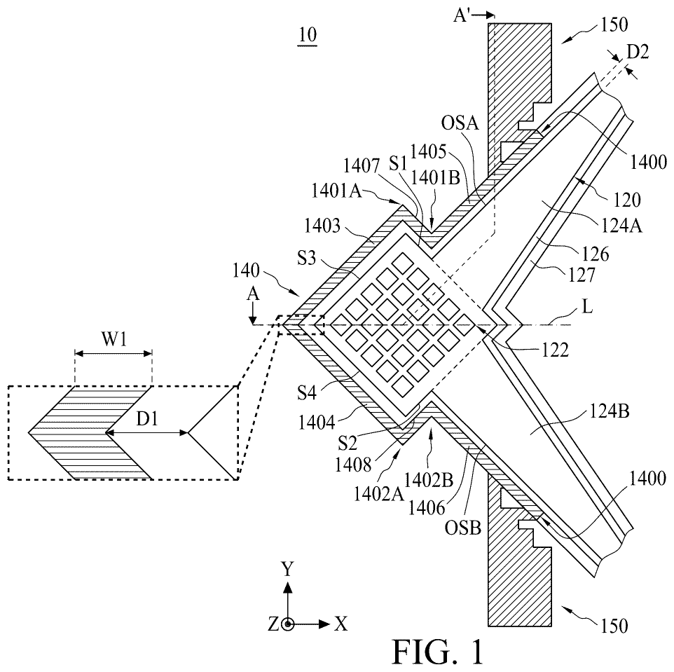

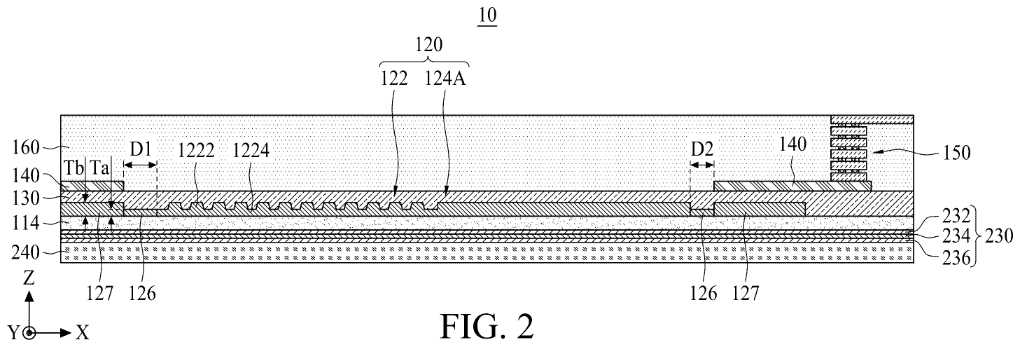

FIG. 1 is a schematic top view of a semiconductor photonic device 10, in accordance with some embodiments of the present disclosure, and FIG. 2 is a schematic cross-sectional view along a line A-A′ of the semiconductor photonic device 10 in FIG. 1. The line A-A′ is a piecewise linear line instead of a straight line. Referring to FIGS. 1 and 2, in some embodiments, the semiconductor photonic device 10 is a portion of a photonic integrated circuit (PIC) that conveys optical signals (i.e., light beams) between the PIC and an optical fiber. The semiconductor photonic device 10 includes a thermally-tuning photonic component, e.g., an optical coupler 120, a temperature control member 140 partially encircling the optical coupler 120 from a top-view perspective, and a first heat transfer member 127 proximal to the optical coupler 120. The first heat transfer member 127 may be used to transfer heat from the temperature control member 140 to the optical coupler 120.

The optical coupler 120 is, for example, a two-dimensional (2D) grating coupler. The 2D grating coupler may serve as a polarization splitter. In some embodiments, the 2D grating coupler is configured to direct a first polarization component of a received optical signal to a first optical path, and to direct a second polarization component of the received optical signal to a second optical path. The optical coupler 120 may include a grating section 122 and a pair of guiding sections 124A and 124B integrated with the grating section 122. In some embodiments, the guiding sections 124A and 124B are symmetric to each other about a diagonal line L crossing the grating section 122. The pair of guiding sections 124A and 124B are approximately perpendicular to each other. In some embodiments, from the top-view perspective, the shape of the grating section 122 is substantially a rhombus, and the guiding sections 124A and 124B are connected to two adjacent sides S1 and S2 of the grating section 122, respectively. Other two adjacent sides S3 and S4 of the grating section 122 are not connected to the guiding sections 124A and 124B. The sides S3 and S4 of the grating section 122 may also be referred to as free sides.

The grating section 122 includes an array of scattering elements 1222 arranged in a planar layer 1224. Each of the guiding sections 124A and 124B may have a tapered structure; from a top-view perspective, a width of the tapered structure gradually decreases at an increasing distance from its interface with the grating section 122. The grating section 122 and the guiding sections 124A and 124B are formed in a semiconductor layer, e.g., a silicon layer. In some embodiments, the semiconductor layer may be a layer of a silicon-on-insulator (SOI) substrate.

A wavelength of the optical signal conveyed into or out of the optical coupler 120 can be determined by a refractive index of a material of the optical coupler 120. The refractive index of the material of the optical coupler 120 may vary with temperature. The temperature control member 140 is adapted to provide a desired temperature of the optical coupler 120 and therefore implement a desired wavelength shift of the optical signal. The temperature control member 140 may provide improved transmission performance to the semiconductor photonic device 10 at wavelengths of interest. The temperature control member 140 is disposed over the optical coupler 120, i.e., the optical coupler 120 and the temperature control member 140 are disposed at different vertical levels. The temperature control member 140 may have a width WI equal to or greater than about 2.5 μm (e.g., equal to about 3 μm). In some embodiments, the temperature control member 140 is a metal trace. The temperature control member 140 may be a metal heater. The temperature control member 140 may be made of tungsten.

In some embodiments, the temperature control member 140 is arranged along an outer side OSA of the guiding section 124A, a portion of the side S1 exposed through the guiding section 124A, the free side S3 of the grating section 122, the free side S4 of the grating section 122, a portion of the side S2 exposed through the guiding section 124B, and an outer side OSB of the guiding section 124B. In some embodiments, free ends 1400 of the temperature control member 140 are physically and electrically connected to an interconnect structure 150. In some embodiments, a voltage is applied to the temperature control member 140 from the interconnect structure 150.

The temperature control member 140 may include a plurality of segments 1403 to 1408. In some embodiments, the segment 1403 is arranged along the free sideS3, the segment 1404 is arranged along the free side S4, the segment 1405 is arranged along the outer side OSA of the guiding section 124A, the segment 1406 is arranged along the outer side 124B of the guiding section 124B, the segment 1407 connects the segment 1403 to the segment 1405, and the segment 1408 connects the segment 1404 to the segment 1406. The segments 1403 to 1408 may be in a strip shape, a linear shape or a curved shape. In some embodiments, the temperature control member 140 further includes a plurality of sharp corners, e.g., the sharp corners 1401A, 1401B, 1402A and 1402B. The sharp corner 1401A is at a position where the segments 1403 and 1407 are connected. The sharp corner 1401B is at a position where the segments 1405 and 1407 are connected. The sharp corner 1402A is at a position wherein the segments 1404 and 1408 are connected, and the sharp corner 1402B is at a position where the segments 1406 and 1408 are connected. The sharp corners 1401A, 1401B, 1402A and 1402B may result in current crowding effect that can lead to non-uniform temperature distribution as the segments 1403 and 1404 tend to be heater than the segments 1405 and 1406 when the temperature control member 140 has a uniform width. Hence, when the temperature control member 140 is separated from the optical coupler 120 by a uniform distance, localized overheating of the grating section 122 of the optical coupler 120 may occur.

In some embodiments, from a top-view perspective, the temperature control member 140 is in a curved shape, and separated from the optical coupler 120 by non-uniform distances equal to or greater than about 0.5 μm to prevent localized overheating and achieve desirable heating performance. For example, the free sides S3 and S4 of the grating section 122 are separated apart from a closest portion of the temperature control member 140 (i.e. the segments 1403 and 1404) by a first distance D1, and the sides S1 and S2 of the grating section 122 are separated apart from a closest portion of the temperature control member 140 (i.e., the segments 1405 and 1406) by a second distance D2. In some embodiments, the first distance D1 is equal to about 1.5 μm, the second distance D2 is greater than 0.1 μm and less than 1.5 μm. The temperature control member 140 arranged far away from optical coupler 120 may lead to a poor heating effect, therefore, each of the first and second distances D1 and D2 is not greater than 5 μm. The first and second distances D1 and D2 may prevent heat from accumulating in a particular portion of the optical coupler 120 and allow for a more precise temperature control of the optical coupler 120. Although FIG. 1 shows merely the first and second distances are difference, the scope of this application is not limited thereto.

The semiconductor photonic device 10 may further include a second heat transfer member 126, wherein the second heat transfer member 126 connects the optical coupler 120 to the first heat transfer member 127. Referring to FIG. 2, in some embodiments, the first heat transfer member 127 has a bottom surface flush with a bottom surface of the optical coupler 120. In some embodiments, the second heat transfer member 126 has a thickness Ta, and the first heat transfer member 127 has a thickness Tb greater than the thickness Ta. The scattering elements 1222 of the grating section 122 and the guiding section 124A may have the thickness Tb. The second heat transfer member 126 may be able to confine light beams entering the optical coupler 120 due to the reduced thickness Ta. The second heat transfer member 126 may have a non-uniform width. For example, a portion of the second heat transfer member 126 connected to the free sides S3 and S4 of the grating section 122 may have a first width substantially equal to the distance D1. In addition, another portion of the second heat transfer member 126 connected to the sides S1 and S2 of the grating section 122, the outer side OSA of the guiding section 124A, and the outer side 124B of the guiding section 124B may have a second width substantially equal to the distance D2. In some embodiments, the first heat transfer member 127 and the second heat transfer member 126 are collectively referred to as a heat transfer member of the semiconductor photonic device 10.

In some embodiments, the temperature control member 140 overlaps a left side portion of the first heat transfer member 127 (i.e., a portion of the first heat transfer member 127 located at the left side of the optical coupler 120) from a top-view perspective. A right side portion of the first heat transfer member 127 (i.e., another portion of the first heat transfer member 127 located at the right side of the optical coupler 120) and the second heat transfer member 126 may be exposed and uncovered by the temperature control member 140 from the top-view perspective. In some embodiments, the left side portion and the right side portion of the first heat transfer member 127 may have same or different widths. The first heat transfer member 127 and the second heat transfer member 126 may be formed in the semiconductor layer where the optical coupler 120 is disposed. In some embodiments, the first heat transfer member 127 and the second heat transfer member 126 are integrated with the optical coupler 120.

Referring to FIG. 2, the semiconductor photonic device 10 further includes an insulator layer 114, an isolation layer 130, and an inter-layer dielectric (ILD) layer 160. In some embodiments, the insulator layer 114 and the isolation layer 130 are disposed on opposite sides of the optical coupler 120. The optical coupler 120, the first heat transfer member 127, and second heat transfer member 126 are disposed on the insulator layer 114. The isolation layer 130 is disposed between the optical coupler 120 and the ILD layer 160, between the second heat transfer member 126 and the ILD layer 160, between the first heat transfer member 127 and the temperature control member 140, between the insulator layer 114 and the temperature control member 140, and between the insulator 114 and the ILD layer 160. The temperature control member 140 and the interconnect structure 150 may be laterally surrounded by the ILD layer 160.

The semiconductor photonic device 10 also includes a thermal preservation layer 230 underlying the insulator layer 114 and a passivation layer 240 underlying the thermal preservation layer 230. The thermal preservation layer 230 includes at least one dielectric material having a thermal conductivity less than a thermal conductivity of the optical coupler 120. In some embodiments, the thermal preservation layer 230 is a multilayered structure including a top film 232 adjacent to the insulator layer 114, a bottom film 236 adjacent to the passivation layer 240, and a middle film 234 between the top and bottom films 232 and 236. The top film 232 and the bottom film 236 may include a same dielectric material, such as silicon nitride. The middle film 234 includes, for example, silicon dioxide. The thermal preservation layer 230 may have an effective thermal conductivity greater than a thermal conductivity of the insulator layer 114 when the insulator layer 114 includes oxide.

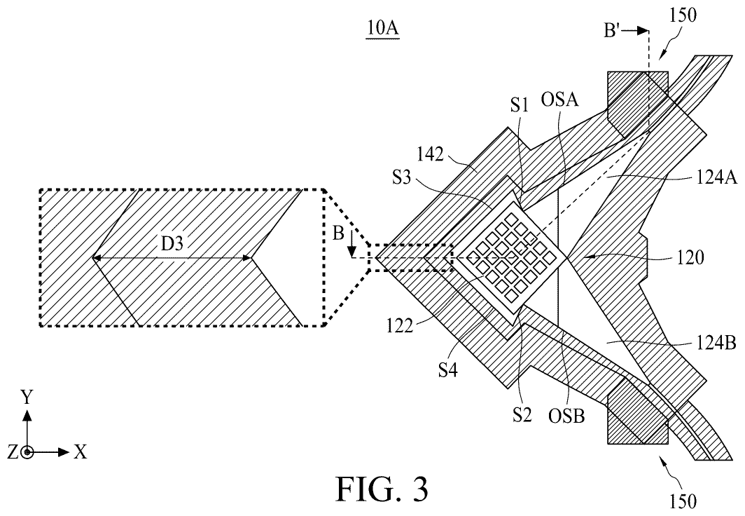

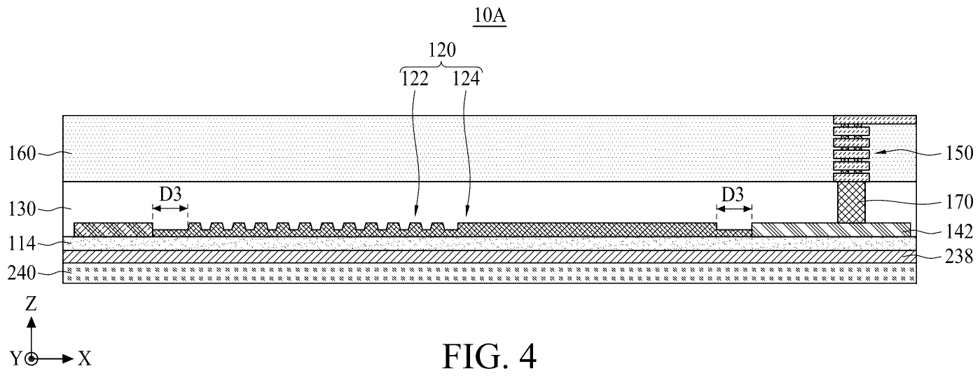

FIG. 3 is a schematic top view of a semiconductor photonic device 10A, in accordance with some embodiments of the present disclosure, and FIG. 4 is a schematic cross-sectional view along a line B-B′ of the semiconductor photonic device 10A in FIG. 3. The semiconductor photonic device 10A, shown in FIG. 3, is essentially the same as the semiconductor photonic device 10 shown in FIG. 1 except for a difference in composition of the temperature control member 142 and the thermal preservation layer 238.

Referring to FIGS. 3 and 4, in some embodiments, the temperature control member 142 is a silicon heater. The temperature control member 142 is a doped region in a silicon layer where the optical coupler 120 is disposed. As such, the temperature control member 142 and the optical coupler 120 are disposed at a same vertical level. The doped region contains dopants of desired types. The temperature control member 142 may have a width equal to or greater than 6.5 μm. In some embodiments, the temperature control member 142 is separated from the optical coupler 120 by a distance D3. The distance D3 is, for example, about 3.6 μm.

In some embodiments, the semiconductor photonic device 10A further includes a conductive contact 170 disposed between the temperature control member 142 and the interconnect structure 150. The conductive contact 170 is used to connect the temperature control member 142 to the interconnect structure 150. The optical coupler 120, the temperature control member 142, and the conductive contact 170 are surrounded by the isolation layer 130. The thermal preservation layer 238 has a single-layered structure. The thermal preservation layer 238 includes a dielectric material having a thermal conductivity less than a thermal conductivity of the optical coupler 120. In addition, the insulator layer 114 may have a thermal conductivity less than the thermal conductivity of the thermal preservation layer 238. In some embodiments, the thermal preservation layer 238 includes nitride.

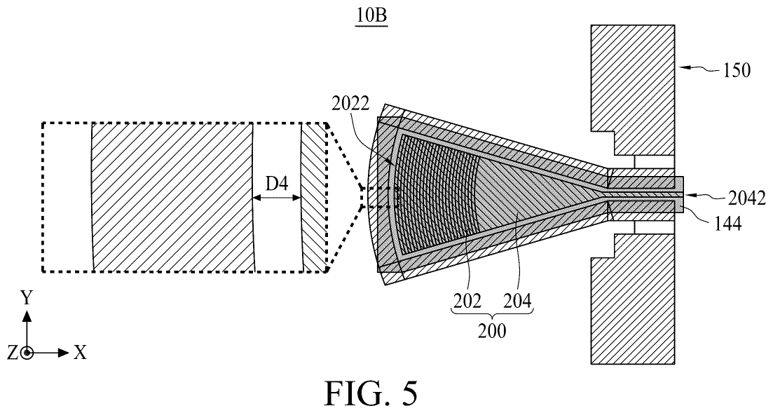

FIG. 5 is a schematic top view of a semiconductor photonic device 10B, in accordance with some embodiments of the present disclosure. Referring to FIG. 5, in some embodiments, the semiconductor photonic device 10B includes a thermally-tuning photonic component, e.g., an optical coupler 200 and a temperature control member 144 partially encircling the optical coupler 200 from a top-view perspective. The optical coupler 200 is a one-dimensional grating coupler. The optical coupler 200 may be formed in a semiconductor layer and is adapted to convey an optical signal between an optical fiber and a PIC. The optical coupler 200 is a portion of the PIC.

The optical coupler 200 includes a grating section 202 and a guiding section 204 integrated with the grating section 202. In some embodiments, the optical coupler 200 may have a tapered shape. The optical coupler 200 may have a width that increases linearly from a free end 2042 of the guiding section 204 to a free end 2022 of the grating section 202. The temperature control member 144 is arranged along a contour around a perimeter of the optical coupler 200 and includes two ends physically and electrically connected to interconnect structures 150, respectively. The temperature control member 144 may be separated from the optical coupler 200 by a uniform distance D4 between about 0.5 μm and about 1.5 μm. The distance D4 is, for example, about 0.9 μm. The interconnect structures 150 may be electrically connected to a control circuitry to drive a current toward the temperature control member 144, so as to heat the optical coupler 200 to a target operating temperature.

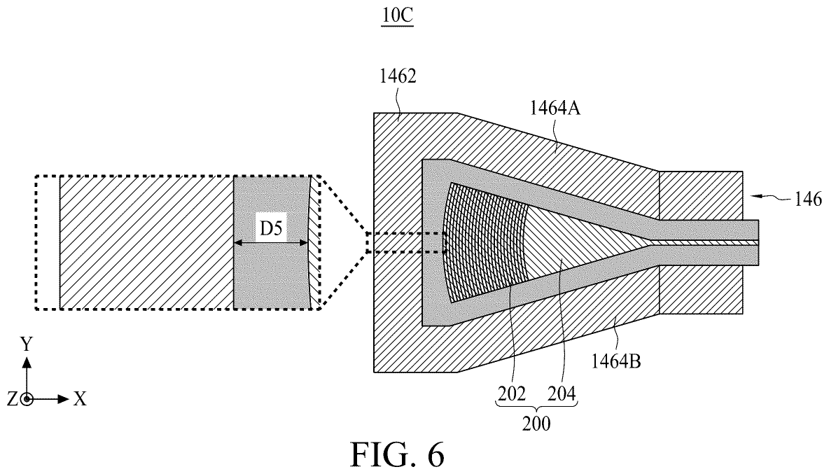

FIG. 6 is a schematic top view of a semiconductor photonic device 10C, in accordance with some embodiments of the present disclosure. The semiconductor photonic device 10C, shown in FIG. 6, is essentially same as the semiconductor photonic device 10B shown in FIG. 5 except for a difference in composition of the temperature control member 146.

Referring to FIG. 6, in some embodiments, the temperature control member 146 is a silicon heater. The temperature control member 146 is a doped region in a silicon layer where the optical coupler 200 is disposed. The temperature control member 146 may have a straight segment 1462 and a pair of piecewise linear segments 1464A and 1464B respectively connected to two ends of the straight segment 1462. The straight segment 1462 of the temperature control member 146 is arranged adjacent to a free end of the grating section 202 of the optical coupler 200. The piecewise linear segments 1464 A and 1464B are arranged along two sidewalls of the optical coupler 200, respectively. In some embodiments, the temperature control member 146 is separated from the optical coupler 200 by a non-uniform distance D5. The distance D5 may be in a range of about 3 μm to 5 μm. The distance D5 between a vertex of the grating section 202 of the optical coupler 200 and the straight segment 1462 is, for example, about 3.2 μm.

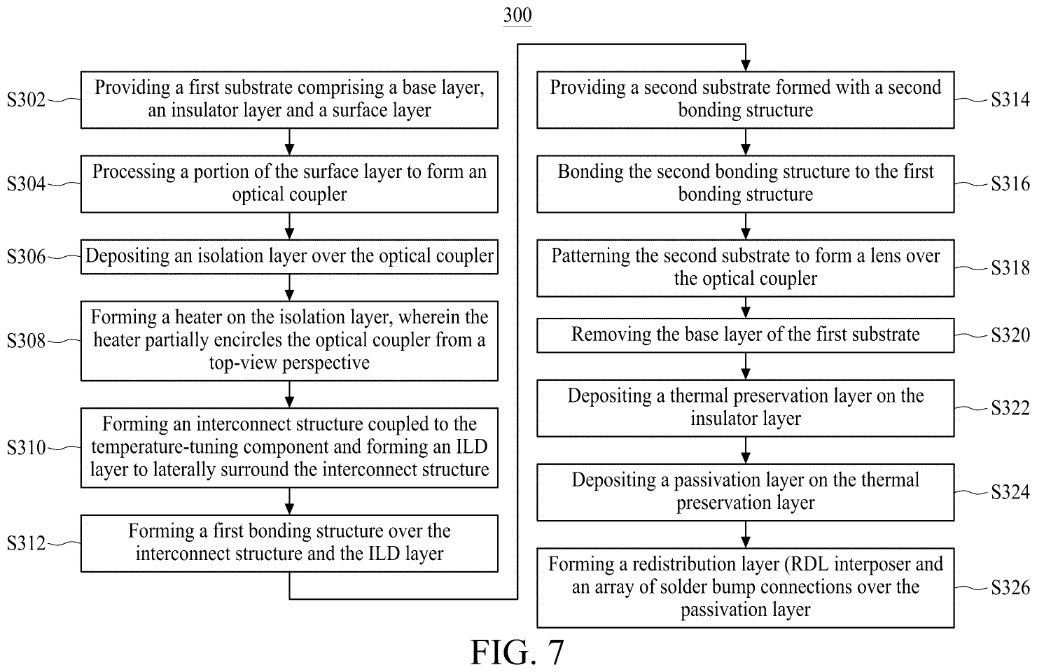

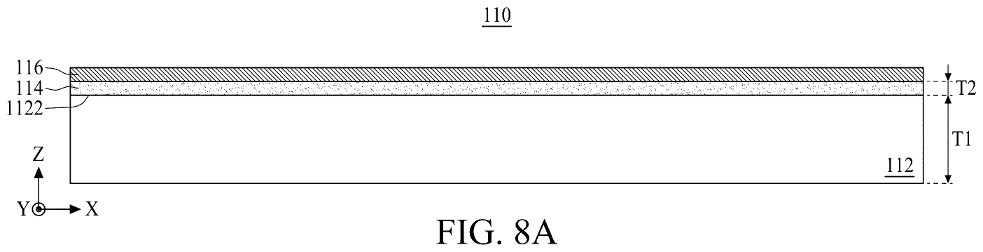

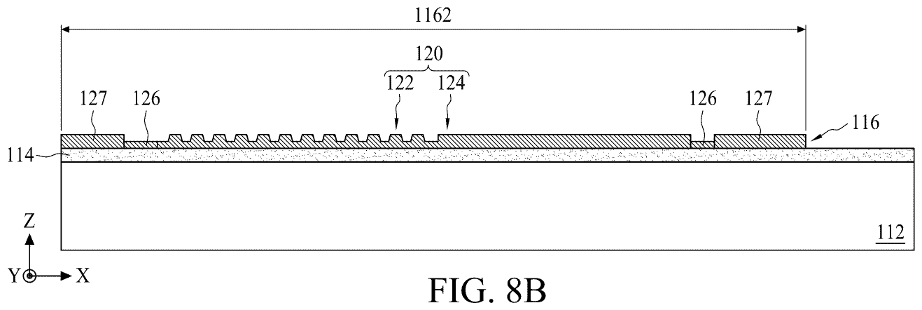

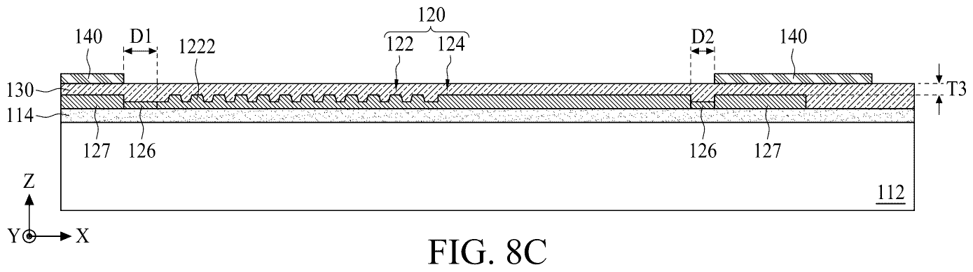

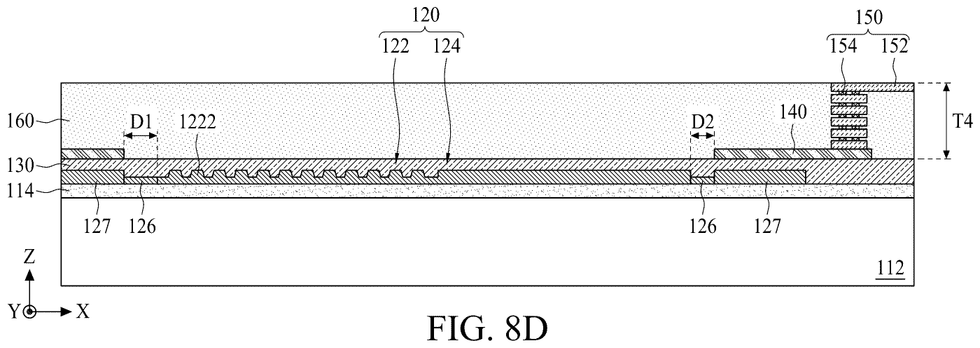

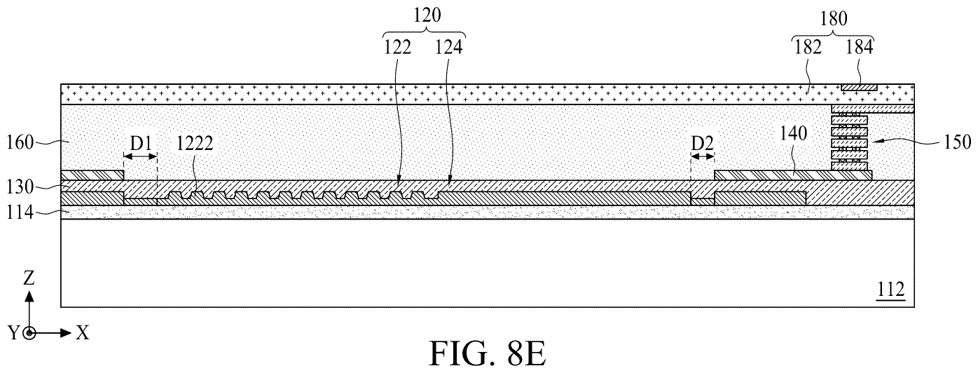

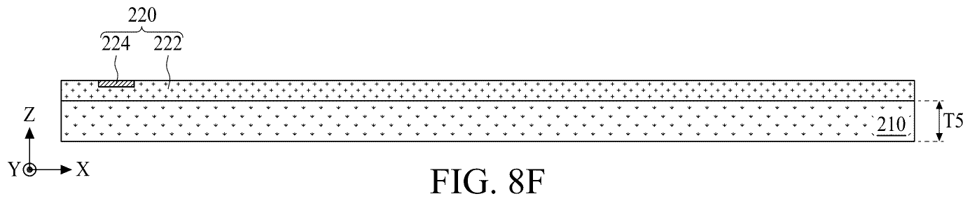

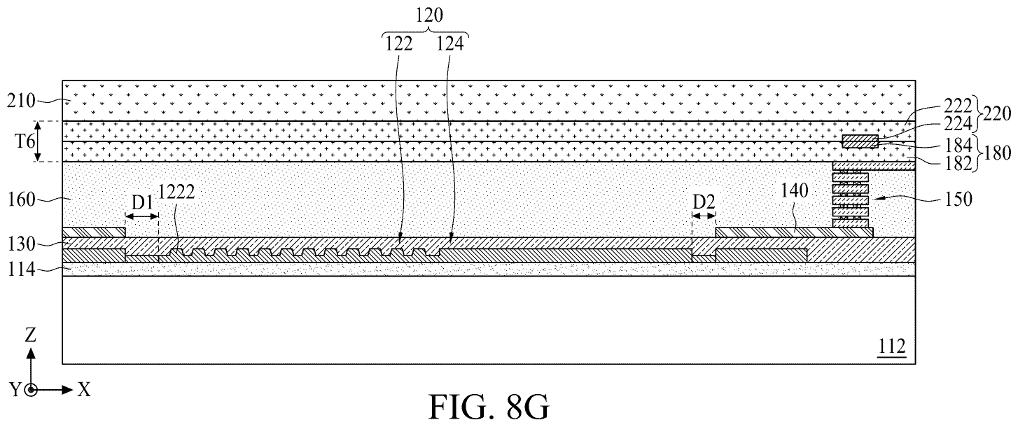

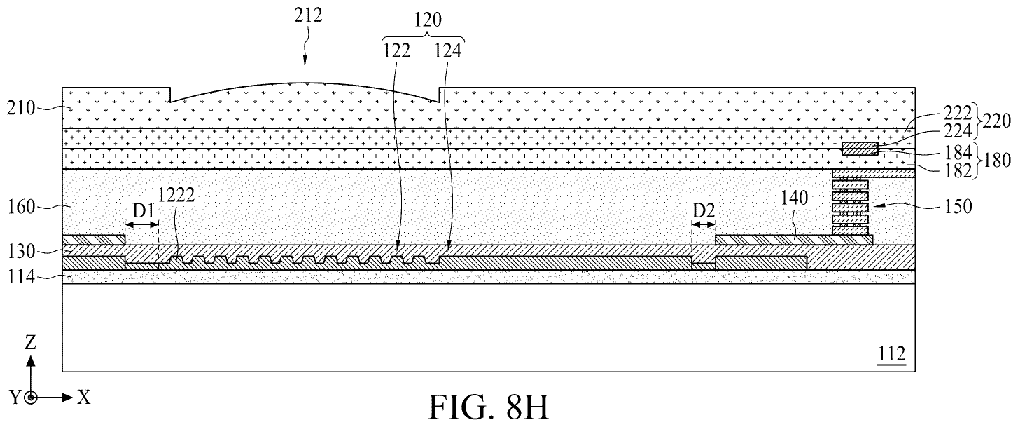

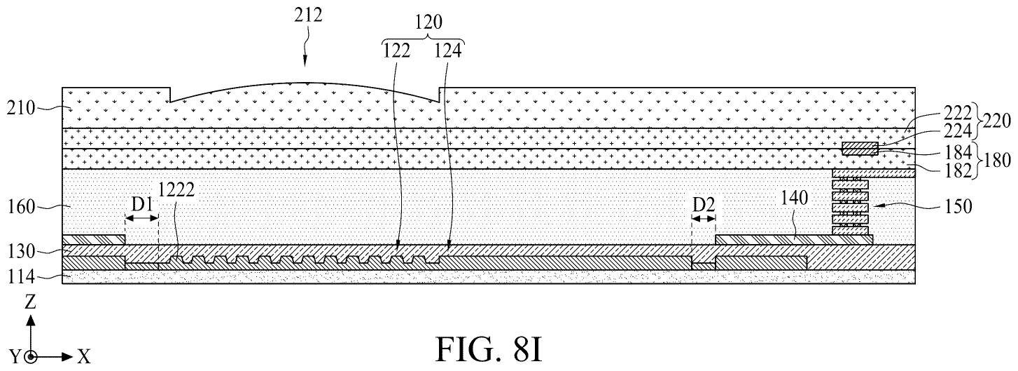

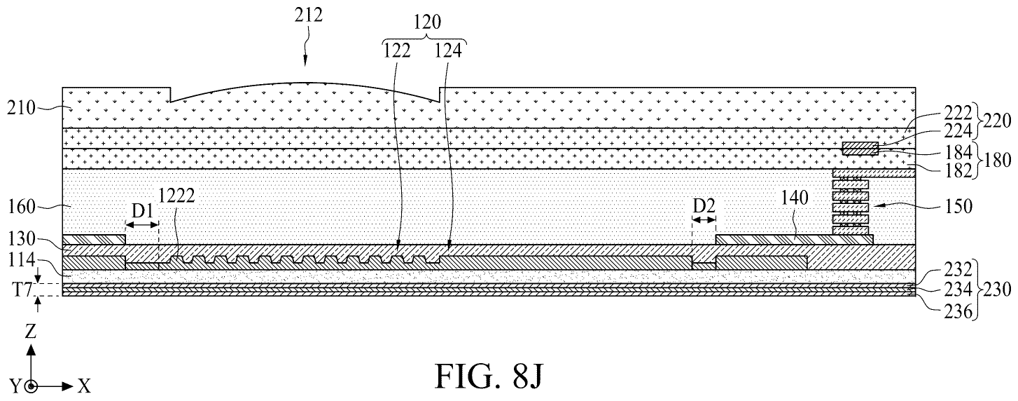

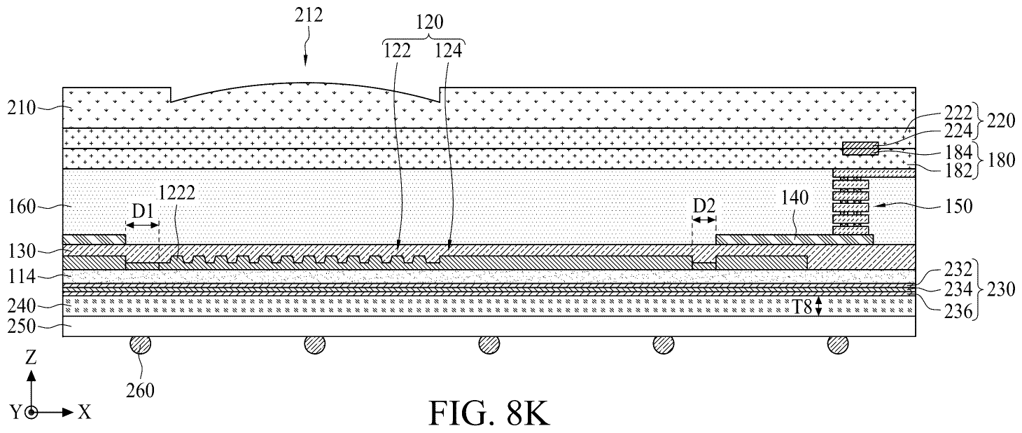

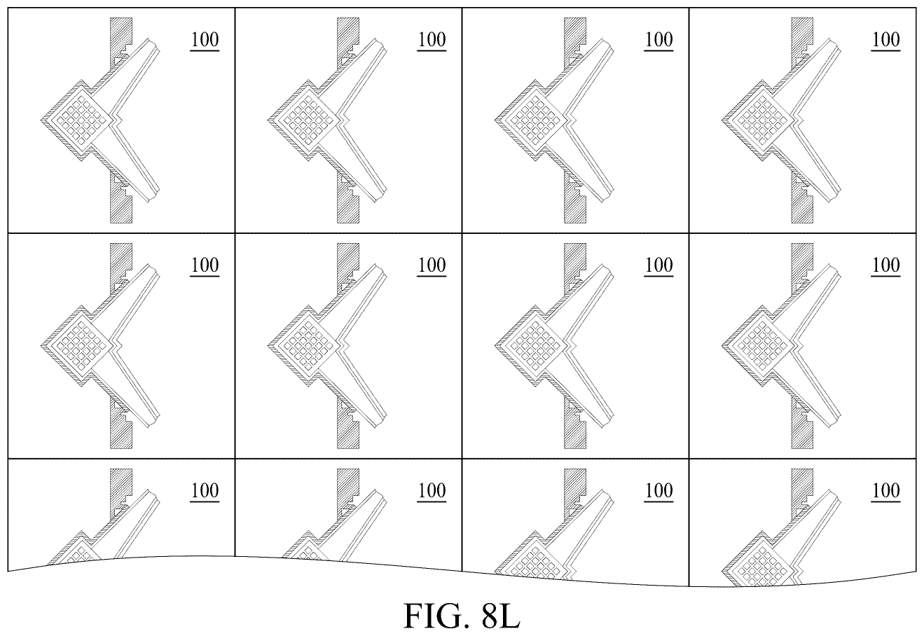

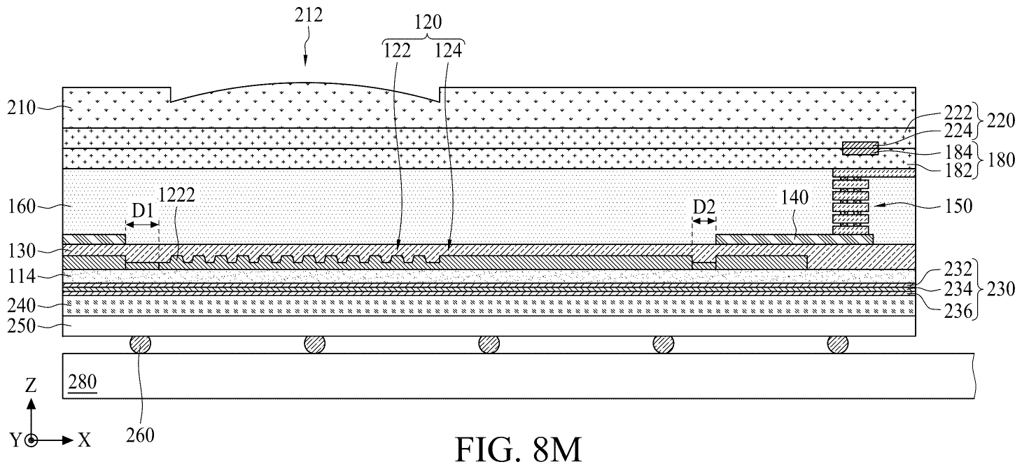

FIG. 7 is a flowchart of a method 300 of manufacturing a semiconductor photonic device 10, in accordance with some embodiments of the present disclosure. FIGS. 8A to 8M are cross-sectional views of intermediate stages of the method 300 of manufacturing the semiconductor photonic device 10, in accordance with some embodiments of the present disclosure. In the following description, the manufacturing stages shown in FIGS. 8A to 8M are discussed with reference to the process steps shown in FIG. 7. It should be understood that additional steps can be provided before, during, and after the steps shown in FIG. 7, and some of the steps described below can be replaced or eliminated, for additional embodiments of the method 300. The order of the steps may be changed.

Referring to FIG. 8A, a first substrate 110 is provided in accordance with step S302 in FIG. 7. The first substrate 110 is a composite substrate, e.g., an SOI substrate, and may include a base layer 112, an insulator layer 114 (also referred to as a buried oxide (BOX) layer), and a surface layer 116 stacked in the Z-direction. The base layer 112 may be composed of any semiconductor material, including but not limited to a silicon-containing semiconductor material, a germanium-containing semiconductor material, or any combination thereof. The base layer 112 may have a first thermal conductivity. For example, the base layer 112 including silicon has a thermal conductivity equal to about 148 W/m*K. In some embodiments, a thickness T1 of the base layer 112 is between about 720 μm and about 780 μm.

The insulator layer 114 overlies the base layer 112. The insulator layer 114 includes dielectric material. For example, the insulator layer 114 includes an oxide (such as silicon oxide), a nitride (such as silicon nitride), or an oxynitride (such as silicon oxynitride). In some embodiments, the insulator layer 114 completely covers an upper surface 1122 of the base layer 112. The insulator layer 114 serves as an electrically insulating layer between the base layer 112 and the surface layer 116. The insulator layer 114 may have a second thermal conductivity less than the first thermal conductivity of the base layer 112. In some embodiments, the insulator layer 114 has a thickness T2 equal to or less than about 2 μm (e.g., in the range from about 0.1 μm to about 2 μm). In some embodiments, the insulator layer 114 including the oxide is formed on the base layer 112 by performing a thermal oxidization operation. The insulator layer 114 including the nitride or the oxynitride may be deposited on the base layer 112 by low pressure chemical vapor deposition (LPCVD) or plasma-enhanced chemical vapor deposition (PECVD).

The surface layer 116 overlies the insulator layer 114 and may include semiconductor material, such as monocrystalline silicon. In some embodiments, the surface layer 116 and the base layer 112 include a same semiconductor material (e.g., monocrystalline silicon), i.e., the surface layer 116 may have the first thermal conductivity. According to some embodiments, the surface layer 116 is formed on the insulator layer 114 by epitaxy to provide better performance.

Referring to FIG. 8B, the surface layer 116 of the first substrate 110 is processed to form at least one optical coupler 120 in accordance with step S304 in FIG. 7. In some embodiments, the surface layer 116 is patterned to form various optical components, including the optical coupler 120. The optical components may further include waveguides, splitters, modulators, resonators, photonic transistors, light detectors, or the like. Two or more of the optical components may compose a silicon-based PIC that receives, processes, or transmits optical signals. The optical signals are conveyed into the PIC through the optical coupler 120.

In some embodiments, the optical coupler 120 is formed in a first region 1162 of the surface layer 116, and therefore, the optical coupler 120 has the first thermal conductivity. The optical coupler 120 includes a grating section 122 and at least one guiding section 124 integrated with the grating section 122. The first region 1162 of the surface layer 116 is further patterned to form a first heat transfer member 127. In some embodiments, the first heat transfer member 127 is integrated with the optical coupler 120. The first heat transfer member 127 may include the second heat transfer member 126, wherein the second heat transfer member 126 connects the optical coupler 120 to the first heat transfer member 127. The first heat transfer member 127 and the second heat transfer member 126 may be formed simultaneously with the optical coupler 120. One or more patterning operations are performed to form the optical coupler 120 and the heat transfer members 126, 127. In some embodiments, the optical coupler 120 and the heat transfer members 126, 127 are formed using photolithography and etching operations. The etching operations may include a wet etch, a dry etch, a combination thereof (e.g., reactive ion etch (RIE)), or the like. The grating section 122 and the guiding section 124 of the optical coupler 120 and heat transfer members 126, 127 may be formed with different photolithography and etching operations.

Referring to FIG. 8C, an isolation layer 130 is deposited over the optical coupler 120 in accordance with step S306 in FIG. 7. The isolation layer 130 may surround the heat transfer members 126, 127 and the optical coupler 120. The isolation layer 130 may have a first refractive index, and the heat transfer members 126, 127 and the optical coupler 120 may have a second refractive index greater than the first refractive index. In addition, the insulator layer 114 of the first substrate 110 may have a third refractive index less than the second refractive index. With such configuration, light can be confined in the optical components, thereby reducing optical loss.

The isolation layer 130 includes dielectric material. The dielectric material may include an oxide (e.g., silicon dioxide), a low-k material, or an ultra-low k dielectric material. The isolation layer 130 may be formed by any suitable technique, such as chemical vapor deposition (CVD), physical vapor deposition (PVD), atomic layer deposition (ALD), and/or other suitable methods. In some embodiments, a planarizing process can be optionally performed after the deposition of the isolation layer 130 to yield an acceptably flat topology.

Subsequently, a temperature control member 140 is formed on the isolation layer 130 in accordance with step S308 in FIG. 7. In some embodiments, the temperature control member 140 is a patterned metal layer and partially covers the isolation layer 130. As shown in FIG. 8C, the optical coupler 120 and the temperature control member 140 are disposed at different vertical levels. In some embodiments, a portion of the isolation layer 130 between the upper surface of the optical coupler 120 and the temperature control member 140 may have a thickness T3 less than the thickness T2 of the insulator layer 114. The thickness T3 is equal to or less than about 1 μm (e.g., in the range from about 0.1 μm to about 1 μm).

The temperature control member 140 may overlap a portion of the first heat transfer member 127. The temperature control member 140 does not overlap the optical coupler 120 and the second heat transfer member 126. In some embodiments, the temperature control member 140 is separated from the grating section 122 of the optical coupler 120 by a distance D1, and the temperatures control member 140 is separated from the guiding section 124 of the optical coupler 120 by a distance D2. The distance D1 may be the same or different from the distance D2. In some embodiments, the distances D1 and D2 are equal to or greater than about 0.5 μm. For example, the distances D1 and D2 are in the range from about 0.5 μm to about 5 μm. The temperature control member 140 may include tungsten, copper, or other conductive metals. The temperature control member 140 may be formed by blanket deposition using a plating technique (such as electroplating or electroless plating, a sputtering operation, or a PVD operation) and patterning a conductive layer using photolithography and etching operations.

Referring to FIG. 8D, an interconnect structure 150 is formed on the temperature control member 140 and an inter-layer dielectric (ILD) layer 160 is deposited to laterally surround the interconnect structure 150 in accordance with step S310 in FIG. 7. The interconnect structure 150 is physically and electrically connected to the temperature control member 140. The interconnect structure 150 does not overlap the optical coupler 120 for preventing the interconnect structure 150 from blocking an incoming optical signal to be incident to the grating section 122 of the optical coupled 120. The interconnect structure 150 and/or the ILD layer 160 may have a thickness T4 between about 8 μm and about 12 μm.

The interconnect structure 150 may include a plurality of metal lines 152 and one or more conductive vias 154 stacked in an alternating manner to electrically connect the temperature control member 140 to an external circuitry. For a purpose of illustration, arrangements and numbers of the metal lines 152 and the conductive vias 154 shown in FIG. 8E are merely exemplary. The actual positioning and configuration of the metal lines 152 and the conductive vias 154 may vary depending on design needs and manufacturing requirements. For example, the interconnect structure 150 may include tungsten, copper, silver, titanium, polysilicon, or another suitable conductive material. A bottommost metal line 152 of the interconnect structure 150 may be in contact with the temperature control member 140. In some embodiments, a topmost metal line 152 of the interconnect structure 150 has an upper surface flush with an upper surface of the ILD layer 160. The ILD layer 160 may include material such as tetraethylorthosilicate (TEOS), undoped silicate glass, phosphosilicate glass (PSG), boron doped silicon glass (BSG), borophosphosilicate glass (BPSG), fused silica glass (FSG), and/or other suitable dielectric materials. The interconnect structure 150 may be formed using a damascene method.

Referring to FIG. 8E, a first bonding structure 180 is formed on the interconnect structure 150 and the ILD layer 160 in accordance with step S312 in FIG. 7. The first bonding structure 180 includes a first bonding dielectric layer 182 and one or more first bonding contacts 184 surrounded by the first bonding dielectric layer 182. The first bonding contacts 184 do not overlap the grating section 122 of the optical coupler 120 (from the top-view perspective). In some embodiments, an upper surface of the first bonding dielectric layer 182 is flush with upper surfaces of the first bonding contacts 184. The first bonding dielectric layer 182 may include silicon dioxide, and examples of processes for depositing the first bonding dielectric layer 182 include spin-coating, CVD, PVD, ALD, and other applicable processes. In some embodiments, the first bonding dielectric layer 182 may be planarized, such as by a chemical mechanical polishing (CMP) operation, to have a planar top surface.

In some embodiments, the first bonding contacts 184 are formed using a damascene process, wherein the first bonding dielectric layer 182 is deposited over the interconnect structure 150 and the ILD layer 160, and the first bonding dielectric layer 182 is patterned using lithography. A conductive material is then deposited over the patterned first bonding dielectric layer 182, and excess portions of the conductive material are removed from the top surface of the first bonding dielectric layer 182 using a CMP operation, an etch operation, or combinations thereof to form the first bonding contacts 184.

Referring to FIG. 8F, a second substrate 210 formed with a second bonding structure 220 is provided in accordance with step S314 in FIG. 7. In some embodiments, the second substrate 210 includes silicon-containing material. For example, the second substrate 210 includes monocrystalline silicon. The second substrate 210 may have a thickness T5 between about 730 angstroms and about 780 micrometers. For example, the thickness T5 is about 775 μm.

The second bonding structure 220 includes a second bonding dielectric layer 222 and one or more second bonding contacts 224 disposed in the second bonding dielectric layer 222. In some embodiments, an upper surface of the second bonding dielectric layer 222 is flush with upper surfaces of the second bonding contacts 224. The second bonding dielectric layer 222 may be formed of a material same as a material of the first bonding dielectric layer 182, and the second bonding contacts 224 may be formed of a material same as a material of the first bonding contacts 184. The second bonding structure 220 may be formed in a manner similar to that used to form the first bonding structure 180.

Referring to FIG. 8G, the second bonding structure 220 is bonded to the first bonding structure 180 in accordance with step S316 in FIG. 7. The second bonding structure 220 is flipped, i.e., tilted by 180 degrees, from an orientation shown in FIG. 8F. The bonding of the first bonding structure 180 to the second bonding structure 220 is achieved by aligning the second bonding contact 224 of the second bonding structure 220 with the first bonding contact 184 of first bonding structure 180. The alignment of the first and second bonding structures 180 and 220 is achieved, for example, using optical sensing. The second bonding dielectric layer 222 of the second bonding structure 220 is also aligned with the first bonding dielectric layer 182 of the first bonding structure 180. After the alignment of the first and second bonding structures 180 and 220, the first and second bonding structures 180 and 220 are bonded together using a hybrid bonding operation.

In some embodiments, the hybrid bonding operation includes a fusion operation that forms a dielectric-to-dielectric bond between the first and second bonding dielectric layers 182 and 222 and a metal-to-metal bonding operation that forms a metal-to-metal bond between the first and second bonding contacts 184 and 224. The metal-to-metal bond does not overlap the grating section 124 of the optical coupler 120. In some embodiments, the first and second bonding structures 180 and 220 have a combined thickness T6 between about 15 μm and about 25 μm.

Referring to FIG. 8H, the second substrate 210 is patterned to form a lens 212 over the optical coupler 120 in accordance with step S318 in FIG. 7. The lens 212 directs and focuses an incoming optical signal toward the grating section 122 of the optical coupler 120. In some embodiments, the relative positions of the grating section 122 of the optical coupler 120 with respect with to the lens 212 is adjusted according to an incident direction of the incoming optical signal. In some embodiments, the lens 212 may partially or fully overlap the grating section 122 of the optical coupler 120. The lens 212 may be offset from the grating section 122 of the optical coupler 120. The lens 212 may be formed using photolithography and etching operations.

Referring to FIG. 81, the base layer 112 of the first substrate 110 is removed from the insulator layer 114 in accordance with step S320 in FIG. 7. In some embodiments, an entirety of the base layer 112 of the first substrate 110 is removed. A planarization operation may be performed to remove the base layer 112 of the first substrate 110. The planarization process may include, for example, a CMP operation, a grinding operation, an etching operation, the like, or combinations thereof.

Referring to FIG. 8J, a thermal preservation layer 230 is deposited on the insulator layer 114 in accordance with step S322 in FIG. 7. The thermal preservation layer 230 may have a thickness T7 equal to or less than the thickness T1 of the base layer of the first substrate 110. In some embodiments, the thickness T7 is equal to or less than about 1 μm. The thermal preservation layer 230 may include a multilayered structure. For example, the thermal preservation layer 230 includes a multilayered dielectric layer with a top film 232, a middle film 234, and a bottom film 236 stacked in the Z-direction. In some embodiments, the top film 232 adjacent to or contacting the insulator layer 114 and the bottom film 236 include a first dielectric material, and the middle film 234 between the top film 232 and the bottom film 236 includes a second dielectric material different from the first dielectric material.

The first dielectric material of the top film 232 and the bottom film 236 has a third thermal conductivity, which is less than the first thermal conductivity of the base layer 112 of the first substrate 110 and the optical coupler 120. The second dielectric material of the middle film 234 may have a fourth thermal conductivity less than the third thermal conductivity. In some embodiments, the first dielectric material includes nitride, and the second dielectric material includes oxide. For example, the first dielectric material of silicon nitride has the second thermal conductivity equal to about 5 W/m*K, and the second dielectric material of silicon dioxide has the third thermal conductivity equal to about 1.4 W/m*K. In some embodiments, the thermal preservation layer 230 including the multilayered structure has an effective thermal conductivity less than the third thermal conductivity and greater than the fourth thermal conductivity, wherein the effective thermal conductivity includes the heat-conducting ability of the top film 232, the middle film 234, and the bottom film 236.

Replacing the base layer 112 of the first substrate 110 with the thermal preservation layer 230 can provide benefits. The temperature control member 140 is operative to generate heat. The heat is transferred from the temperature control member 140, through the isolation layer 130, the first heat transfer member 127, the second heat transfer member 126, and to the optical coupler 120. The transferred heat is further transferred through the insulator layer 114, a layer underlying the insulator layer 114, and to ambient air. In general, a material with greater thermal conductivity will provide better heat dissipation. Thus, heat dissipation can occur more rapidly from the base layer 112 having a high thermal conductivity than from the thermal preservation layer 230 having a low thermal conductivity. When a lot of heat is dissipating, an electric power applied to the temperature control member 140 for maintaining the ambient temperature of the optical coupler 120 within a desired range is increased, raising concerns of high power consumption.

Replacing the base layer 112 with the thermal preservation layer 230 advantageously minimizes heat loss from the resulting structure, thereby improving temperature control and reducing power requirements for the temperature control member 140. Replacing the base layer 112 with the thermal preservation layer 230 also helps to reduce a thickness of the overall device.

Referring to FIG. 8K, a passivation layer 240 is deposited on the thermal preservation layer 230 in accordance with step S324 in FIG. 7. In some embodiments, the passivation layer 240 has a thickness T8 in a range of about 10 μm to about 20 μm. The passivation layer 240 contacts the bottom film 236 of the thermal preservation layer 230. In some embodiments, the passivation layer 240 comprises a dielectric material, such as nitride, oxide, oxynitride or the like. In other embodiments, the passivation layer 240 includes a polymeric material such as polymer, polyimide (PI), benzocyclobutene (BCB), polybenzoxazole (PBO) or the like. In some embodiments, the passivation layer 240 may be formed by spin coating, sputtering or other deposition methods.

Subsequently, a redistribution layer (RDL) interposer 250 and an array of solder bump connections 260 are formed on the passivation layer 240 according to step S326 in FIG. 7. The RDL interposer 250 may include wiring and conductive vias (not shown) with respective dielectric layers. The dielectric layers may include PI, PBO, BCB, and epoxy-based material. The wiring and conductive vias may include conductive material such as copper or aluminum within a refractory metal liner. In some embodiments, the RDL interposer 250 is electrically connected to an electro-optic circuitry formed in another portion of the surface layer 116. The array of solder bump connections 260 is physically and electrically connected to the wiring of the RDL interposer 250. In some embodiments, the array of solder bump connections 260 is implemented using controlled collapse chip connection (C4).

Referring to FIG. 8L, multiple photonic integrated circuits 100 may be formed in the surface layer 116, wherein each of the photonic integrated circuits 100 includes one or more optical couplers 120. After the formation of the solder bump connections 260, the photonic integrated circuits 100 may be separated from one another through a singulation operation. The singulation operation is used to cut through the second substrate 210, and can utilize mechanical saws, lasers, plasma cutting, or chemical etching to perform the singulation. In some embodiments, the singulated photonic integrated circuits 100 are bonded to an organic substrate 280, as shown in FIG. 8M. The singulated photonic integrated circuits 100 may be connected to the organic substrate 280 by the array of solder bump connections 260.

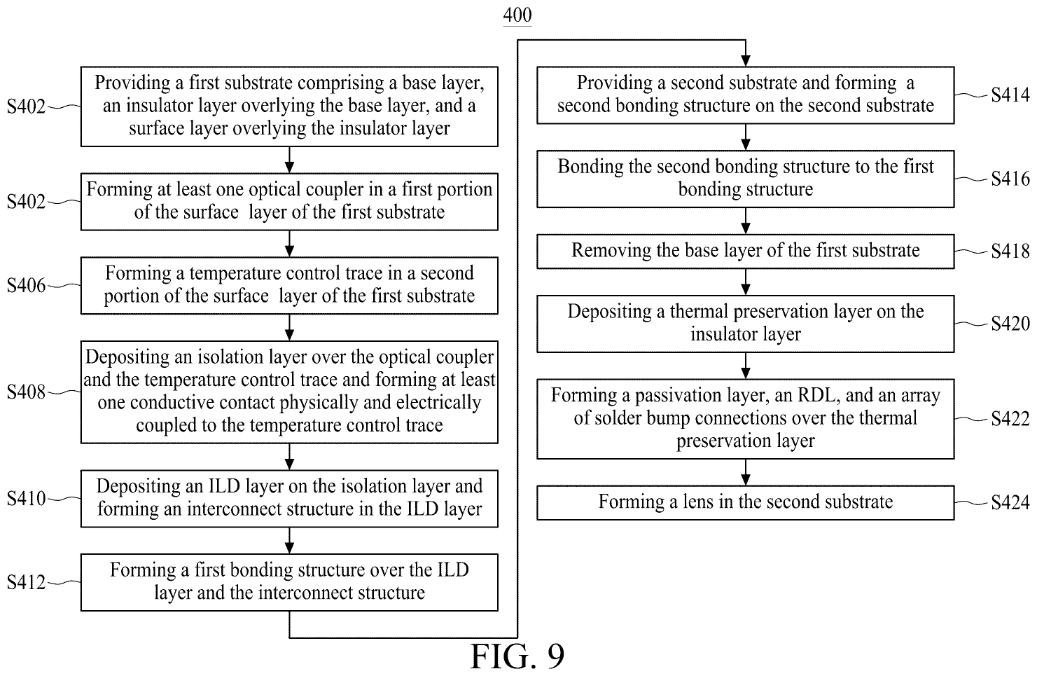

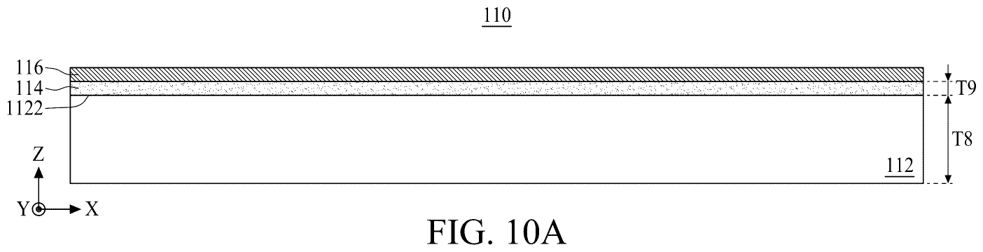

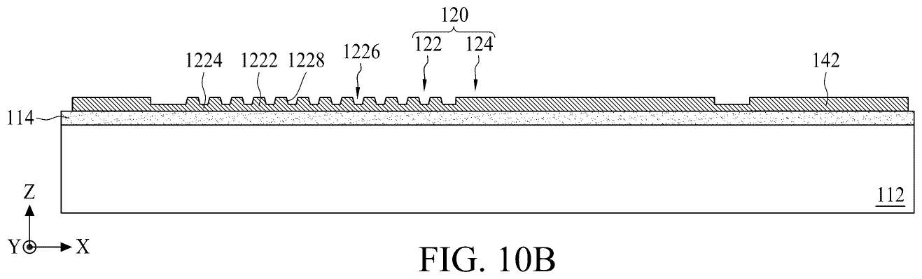

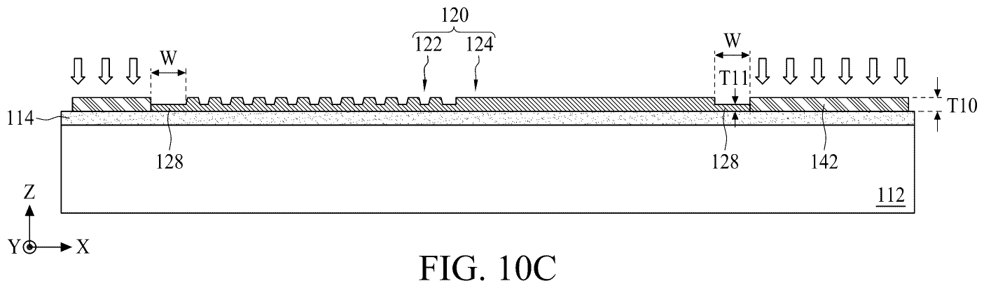

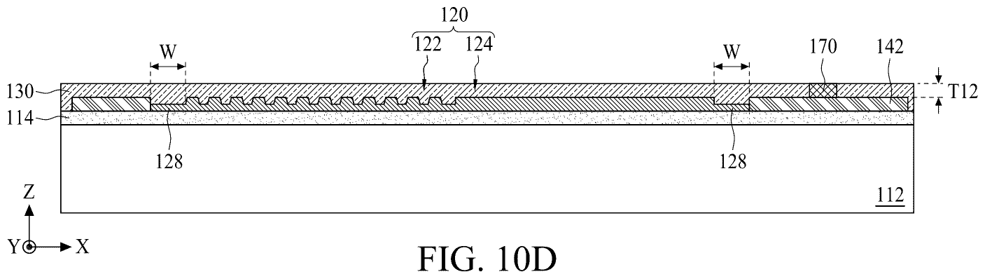

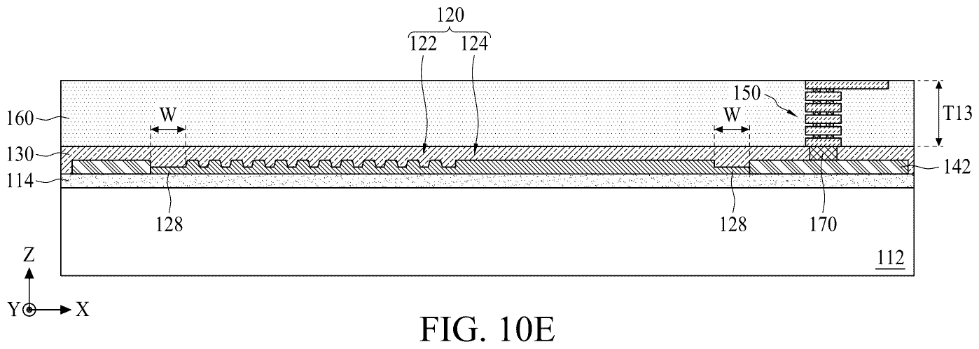

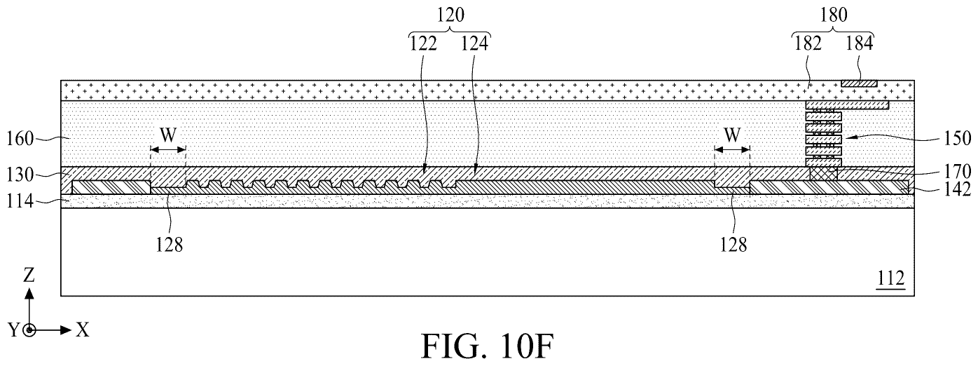

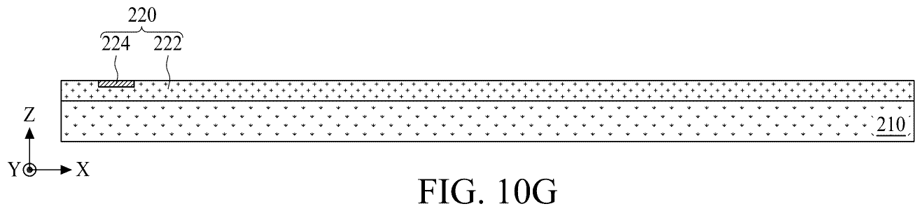

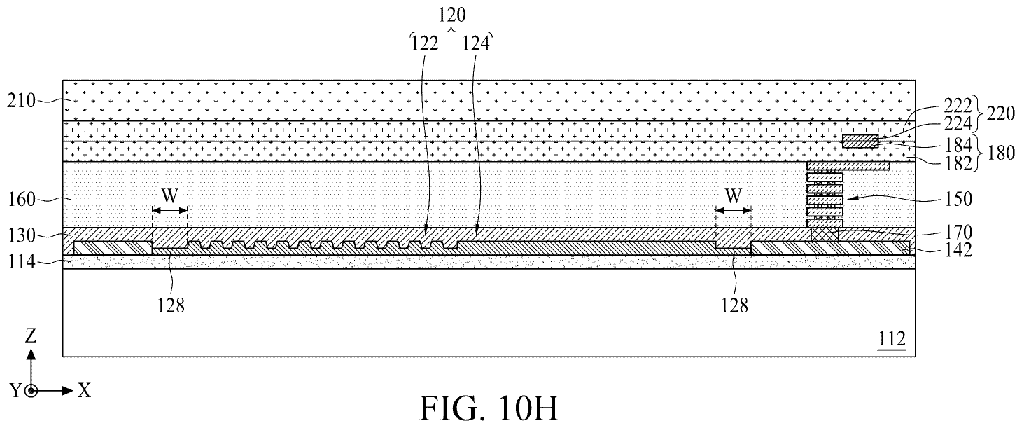

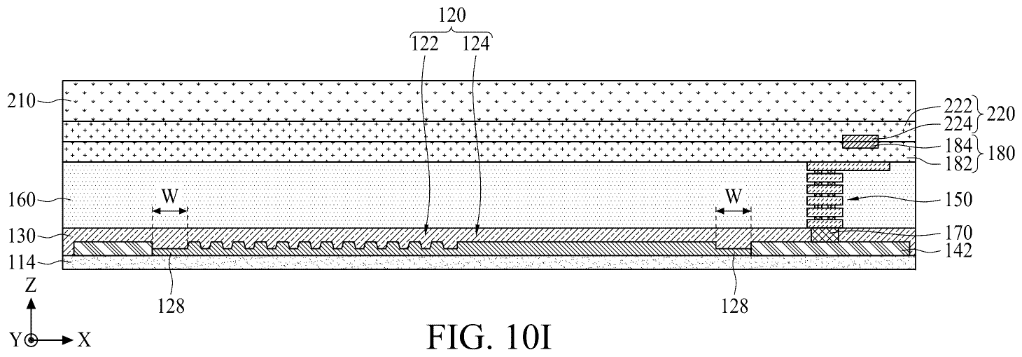

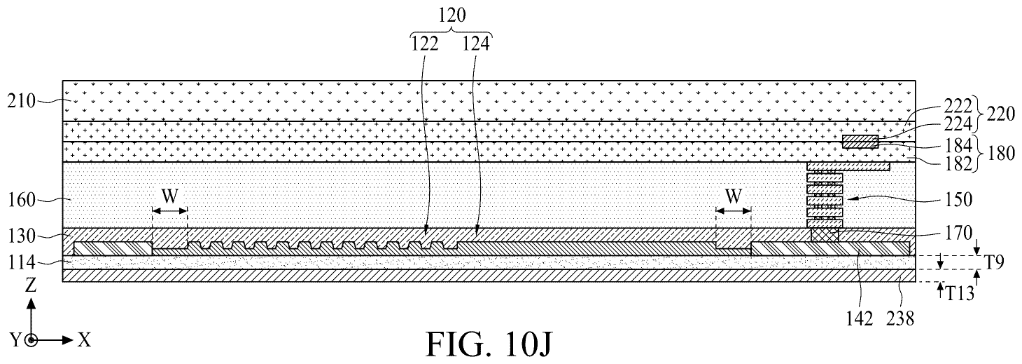

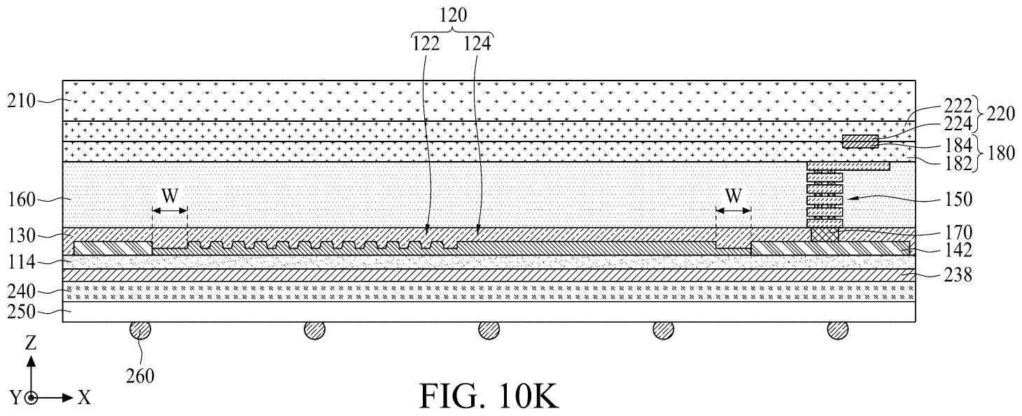

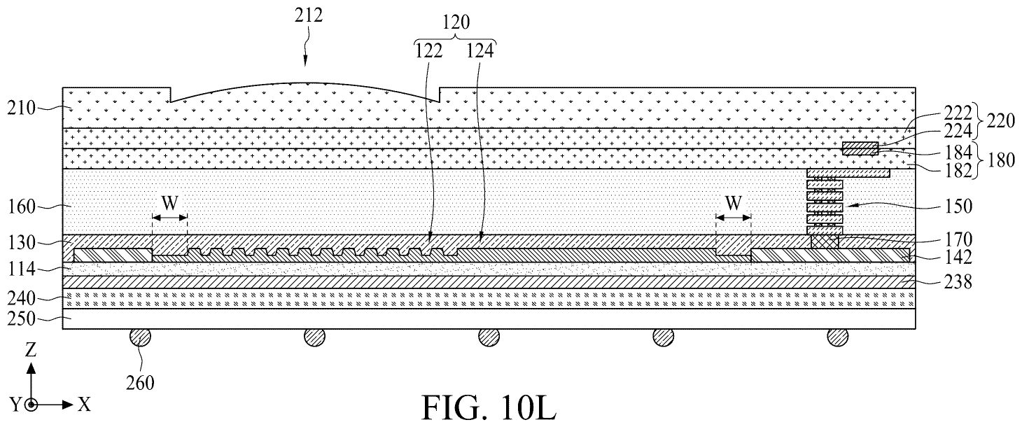

FIG. 9 is a flowchart of a method 400 of manufacturing a semiconductor photonic device 10A, in accordance with some embodiments of the present disclosure. FIGS. 10A to 10L are cross-sectional views of intermediate stages of the method 400 of manufacturing the semiconductor photonic device 10A/10B, in accordance with some embodiments of the present disclosure. In the following description, the manufacturing stages shown in FIGS. 10A to 10L are discussed with reference to the process steps shown in FIG. 9. It should be understood that additional steps can be provided before, during, and after the steps shown in FIG. 9, and some of the steps described below can be replaced or eliminated, for additional embodiments of the method 400. The order of the steps may be changed.

Referring to FIG. 10A, a first substrate 110 is provided in accordance with step S402 in FIG. 9. The first substrate 110 includes a base layer 112, an insulator layer 114 overlying the base layer 112, and a surface layer 116 overlying the insulator layer 114. In some embodiments, the base layer 112 and the surface layer 116 include one or more semiconductor materials, and the insulator layer 114 includes dielectric material. The base layer 112, the insulator layer 114, and the surface layer 116 may be collectively referred to as an SOI substrate. In some embodiments, the base layer 112 has a thickness T8 between about 720 μm and about 780 μm, and the insulator layer 114 has a thickness T9 of about 2 μm. The base layer 112 may have a first thermal conductivity, and the insulator layer 114 may have a second thermal conductivity less than the first thermal conductivity.

Referring to FIG. 10B, at least one optical coupler 120 is formed in a first portion of the surface layer 116 of the first substrate 110 in accordance with step S404 in FIG. 9. In some embodiments, the surface layer 116 of the first substrate 110 is processed to form various optical components, including the optical coupler 120. For example, at least one first region of the surface layer 116 of the first substrate 110 is patterned to form the optical coupler 120. One or more patterning operations are performed to form the optical coupler 120 including a plurality of scattering elements 1222 protruding from a planar layer 1224. The scattering elements 1222 are laterally separated from one another by recesses 1226. The scattering elements 1222 and the recesses 1226 may be formed using photolithography and etching operations. In some embodiments, anisotropic etching techniques can be utilized to form tapered sidewalls 1228 of the scattering elements 1222.

Referring to FIG. 10C, a temperature control member 142 is formed in the surface layer 116 of the first substrate 110 according to step S406 in FIG. 9. In some embodiments, an implantation operation is performed to implant dopants in a second portion of the surface layer 116 in order to form the temperature control member 142 partially encircling the optical coupler 120. As such, the optical coupler 120 and the temperature control member 142 are disposed in a same vertical level. In some embodiments, the temperature control member 142 is formed by implantation of n-type dopants, such as nitrogen or phosphorus. In alternative embodiments, p-type dopants, such as boron, are introduced into the surface layer 116 of the first substrate 110 by ion implantation or diffusion doping to form the temperature control member 142. The temperature control member 142 is a silicon heater.

In some embodiments, a third portion of the surface layer 116 is patterned to form a spacer 128 between the temperature control member 142 and the optical coupler 120. In some embodiments, the spacer 128 has a width W equal to or greater than about 0.5 μm to prevent the temperature control member 142 from directly contacting the optical coupler 120. For example, the width W is in the range from about 0.5 μm to about 5 μm. The heat is transferred from the temperature control member 142, through the spacer 128, and to the optical coupler 120. The width W of the spacer 128 serves to prevent additional optical loss. The temperature control member 142 has a thickness T10, and the spacer 128 has a thickness T11 less than the thickness T10. The optical coupler 120 and the spacer 128 are undoped portions of the surface layer 116. The spacer 128 may be formed using photolithography and etching operations. The spacer 128 may be formed prior to or after the formation of the temperature control member 142. In some embodiments, the spacer 128 is formed during the formation of the optical components.

Referring to FIG. 10D, an isolation layer 130 is deposited over the optical coupler 120 and the temperature control member 142 and a conductive contact 170 is formed to physically and electrically connect to the temperature control member 142 in accordance with step S408 in FIG. 9. The isolation layer 130 may surround and cover the optical coupler 120 and the temperature control member 142. The isolation layer 130 also covers a portion of the insulator layer 114 exposed through the optical coupler 120 and the temperature control member 142. A portion of the isolation layer 130 laterally surround the conductive contact 170 may have a thickness T12 equal to or less than about 1 μm. The isolation layer 130 may include material such as silicon dioxide, a low-k material, or an ultra low-k dielectric material. The isolation layer 130 is formed by CVD, PVD, ALD, and/or other suitable methods.

Referring to FIG. 10E, an ILD layer 160 is deposited on the isolation layer 130 and the conductive contact 170 and an interconnect structure 150 is formed in the ILD layer 160 in accordance with step S410 in FIG. 9. The interconnect structure 150 includes multiple conductive features formed in the ILD layer 160. The conductive features may include conductive lines, conductive vias, and/or conductive contacts. Various processes, such as back-end-of-line (BEOL) semiconductor fabrication processes, are performed to form the interconnect structure 150 and the ILD layer 160. In some embodiments, the optical coupler 120 is not covered by the interconnect structure 150. The interconnect structure 150 and/or the ILD layer 160 may have a thickness T13 between about 8 μm and about 12 μm.

Referring to FIG. 10F, a first bonding structure 180 is formed on the interconnect structure 150 and the ILD layer 160 in accordance with step S412 in FIG. 9. The first bonding structure 180 includes a first bonding dielectric layer 182 and one or more first bonding contacts 184 disposed in the first bonding dielectric layer 182. The first bonding contacts 182 are electrically insulated from the interconnect structure 150 by the first bonding dielectric layer 182.

Referring to FIG. 10G, a second substrate 210 is provided and a second bonding structure 220 is formed on the second substrate 210 in accordance with step S414 in FIG. 9. In some embodiments, the second substrate 210 includes semiconductor material. For example, the second substrate 210 includes monocrystalline silicon. The second bonding structure 220 includes a second bonding dielectric layer 222 and one or more second bonding contacts 224 disposed in the second bonding dielectric layer 222. The second bonding contacts 224 are electrically insulated from the second substrate 210 by the second bonding dielectric layer 222.

Referring to FIG. 10H, the second bonding structure 220 is bonded to the first bonding structure 180 in accordance with step S416 in FIG. 9. In some embodiments, the second bonding structure 220 is hybrid bonded to the first bonding structure 180. The hybrid bonding method includes direct bonding the first bonding contacts 184 of the first bonding structure 180 to the respective second bonding contacts 224 of the second bonding structure 220, and direct bonding the first bonding dielectric layer 182 of the first bonding structure 180 to the second bonding dielectric layer 222 of the second bonding structure 220.

Referring to FIG. 101, the base layer 112 of the first substrate 110 is removed from the insulator layer 114 in accordance with step S418 in FIG. 9. In some embodiments, the base layer 112 of the first substrate 110 is removed using a planarization operation. The planarization process may include, for example, a CMP operation, a grinding operation, an etching operation, the like, or combinations thereof.

Referring to FIG. 10J, a thermal preservation layer 238 is deposited on the insulator layer 114 in accordance with step S420 in FIG. 9. The thermal preservation layer 238 includes dielectric material, such as nitride. The insulator layer 114 of the first substrate 110 and the thermal preservation layer 238 may have different materials. The thermal preservation layer 238 has a third thermal conductivity, which may be less than the first thermal conductivity of the base layer 112 of the first substrate 110. In addition, the third thermal conductivity of the thermal preservation layer 238 may be greater than the second thermal conductivity of the insulator layer 114 of the first substrate 110. The thermal preservation layer 238 may serve as a heat confinement layer, which prevents heat from dissipating out of a bottom side of the resulting device. The thermal preservation layer 238 may have a thickness T13 equal to or less than the thickness T9 of the insulator layer 114. In some embodiments, the thickness T13 is equal to or less than about 1 μm.

Referring to FIG. 10K, a passivation layer 240, an RDL interposer 250, and an array of solder bump connections 260 are subsequently formed on the thermal preservation layer 238 in accordance with step S422 in FIG. 9. The passivation layer 240 and the thermal preservation layer 238 may have different materials. For example, the passivation layer 240 includes a polymeric material such as polymer, PI, BCB, PBO or the like. In some embodiments, the passivation layer 240 may be formed by spin coating, sputtering or other deposition methods. The RDL interposer 250 is bonded to the passivation layer 240. The RDL interposer 250 may include one or more dielectric layers with conductive features (not shown) disposed in the dielectric layers. The array of solder bump connections 260 is formed on a bottom of the RLD interposer 250. The array of solder bump connections 260 is connected to wiring of the RDL interposer 250. The array of solder bump connections 260 permits the resulting structure to be mounted and electrically connected to, for example, a printed circuit board (PCB) or other substrate.

Referring to FIG. 10L, at least one lens 212 is formed in the second substrate 210 in accordance with step S424 in FIG. 9. Consequently, the semiconductor photonic device 10A/10B is completely formed. In some embodiments, the lens 212 is vertically aligned with the optical coupler 120. In some embodiments, the lens 212 includes a concave surface, a convex surface, a spherical surface, an aspherical surface, and/or a free-form curved surface. In other embodiments, the lens 212 can include microstructures, Fresnel lenses, or the like.

In accordance with some embodiments of the present disclosure, a method of manufacturing a semiconductor photonic device includes: providing a first substrate comprising a base layer, an insulator layer overlying the base layer, and a surface layer overlying the insulator layer; forming an optical component in a first region of the surface layer of the first substrate; forming a temperature control member at least partially encircling the optical component; removing the base layer of the first substrate; and depositing a thermal preservation layer on the insulator layer of the first substrate, wherein the base layer of the first substrate has a first thermal conductivity, and the thermal preservation layer has a second thermal conductivity less than the first thermal conductivity.

In accordance with some embodiments of the present disclosure, a method of manufacturing a semiconductor photonic device includes: providing a silicon-on-insulator substrate comprising a base layer, an insulator layer overlying the base layer, and a silicon layer overlying the insulator layer; forming an optical component in a first portion of the silicon layer; forming a temperature control member partially encircling the optical component from a top-view perspective; forming a lens that at least partially overlaps the optical component from the top-view perspective; removing the base layer; and depositing at least one dielectric film on the insulator layer, wherein the base layer has a first thermal conductivity, and the dielectric film has a second thermal conductivity less than the first thermal conductivity.

In accordance with some embodiments of the present disclosure, a semiconductor photonic device includes: a thermal preservation layer; an insulator layer overlying the thermal preservation layer; an optical component disposed on the insulator layer; and a temperature control member partially encircling the photonic component from a top-view perspective, wherein the insulator layer has a first thermal conductivity, and the thermal preservation layer has a second thermal conductivity less than the first thermal conductivity.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of manufacturing a semiconductor photonic device, comprising:
providing a first substrate comprising a base layer, an insulator layer overlying the base layer, and a surface layer overlying the insulator layer;
forming an optical component in a first region of the surface layer of the first substrate;
forming a temperature control member partially encircling the optical component;
removing the base layer of the first substrate; and
depositing a thermal preservation layer on the insulator layer of the first substrate, wherein the base layer of the first substrate has a first thermal conductivity, and the thermal preservation layer has a second thermal conductivity less than the first thermal conductivity.

2. The method of claim 1, wherein the formation of the temperature control member comprises:
implanting a dopant into a second region of the surface layer of the first substrate.

3. The method of claim 1, wherein the optical component and the temperature control member are disposed at different vertical levels.

4. The method of claim 3, wherein the temperature control member is disposed over the optical component.

5. The method of claim 4, further comprising depositing an isolation layer to cover the optical component and the insulator layer of the first substrate.

6. The method of claim 3, further comprising forming a heat transfer member in the surface layer and connected to the optical component, wherein the temperature control member partially overlaps the heat transfer member.

7. The method of claim 6, wherein the heat transfer member is formed simultaneously with the optical component.

8. The method of claim 1, further comprising, prior to the removal of the base layer:
forming a first bonding structure over the optical component and the temperature control member;
providing a second substrate;
forming a second bonding structure on the second substrate;
bonding the second bonding structure to the first bonding structure; and
patterning the second substrate to form a lens over the optical component.

9. The method of claim 8, wherein the first bonding structure is bonded to the second bonding structure through a hybrid bonding comprising a metal-to-metal bonding and a dielectric-to-dielectric bonding.

10. The method of claim 1, wherein the thermal preservation layer has a thickness less than a thickness of the base layer of the first substrate.

11. A method of manufacturing a semiconductor photonic device, comprising:
providing a silicon-on-insulator (SOI) substrate comprising a base layer, an insulator layer overlying the base layer, and a silicon layer overlying the insulator layer;
forming an optical coupler in a first portion of the silicon layer of the SOI substrate;
forming a temperature control member partially encircling the optical coupler;
forming a lens at least partially overlapping the optical coupler from a top-view perspective;
removing the base layer; and
depositing a thermal preservation layer on the insulator layer, wherein the base layer has a first thermal conductivity, and the thermal preservation layer has a second thermal conductivity less than the first thermal conductivity.

12. The method of claim 11, wherein the forming of the optical coupler comprises forming a spacer to isolate the optical coupler from the temperature control member.

13. The method of claim 12, wherein the spacer has a uniform width.

14. The method of claim 12, wherein the spacer comprises a material same as a material of the optical coupler and the temperature control member.

15. The method of claim 14, wherein the optical coupler and the temperature control member are disposed at a same vertical level.

16. The method of claim 11, wherein the temperature control member is, from a top-view perspective, separated from the optical coupler by a non-uniform distance.

17. The method of claim 11, wherein the temperature control member is arranged along a contour around a perimeter of the optical coupler.

18. A semiconductor photonic device, comprising:
a thermal preservation layer;
an insulator layer overlying the thermal preservation layer;
an optical component disposed on the insulator layer; and
a temperature control member partially encircling the optical component from a top-view perspective,
wherein the thermal preservation layer has a first thermal conductivity, and the optical component has a second thermal conductivity greater than the first thermal conductivity.

19. The semiconductor photonic device of claim 18, wherein the temperature control member and the optical component are disposed at a same vertical level.

20. The semiconductor photonic device of claim 18, wherein the temperature control member is disposed over the optical component.
